(19) United States
(12) Patent Application Publication
(10) Pub. No.: US 2004/0103735 A1
(43) Pub. Date: Jun. 3, 2004

(54) Driving gear, especially worm gear

(76) Inventor: Rainer Bruhn, Ingersheim (DE)

Correspondence Address: Andrew R Basile, Young & Basile, Suite 624, 3001 West Big Beaver Road, Troy, MI, 48084, US

(21) Appl. No.: 10/474,047

(22) PCT Filed: Mar. 20, 2002
(86) PCT No.: PCT/EP02/03061

(30) Foreign Application Priority Data
Apr. 12, 2001 (DE) 101 18 387.9

(51) Int. Cl. F16H 1/16

(52) U.S. Cl. 74/425

(57) ABSTRACT

A driving gear, especially a worm gear, includes a drive shaft, an output shaft, a gear housing, a rotating magnetic pole mounted on one of the two shafts, a Hall sensor resting on the gear housing and mounted in the area of the rotating magnetic pole for detecting the rotation of the rotating magnetic pole or the corresponding shaft, and a gear housing cover. The Hall sensor is mounted on a plate that can be inserted in the housing.

The invention relates to a driving gear, specifically a worm gear, having an input shaft, an output shaft, a gear housing, a magnetic pole wheel mounted on one of the two shafts, a Hall-effect sensor located in the area of the pole wheel and supported on the gear housing to detect the rotary motion of the pole wheel, or the corresponding shaft, and a gear housing cover. The invention also relates to an electric drive unit having such a driving gear.

A driving gear of this type is known from DE 44 33 973 A1. Driving gears of this type find an application, for example, in an electric motor-driving gear combination for windshield wiper systems, window regulators, sliding sun roofs or similar.

In order to obtain information about rotation angle and/or rotation angle speed, driving gears of this type have a pole wheel on the corresponding shaft with a Hall-effect sensor to detect the magnetic signals generated by the pole wheel.

In the known prior art, the Hall-effect sensor for this purpose is located in a housing which can be inserted into an opening of the gear housing cover. The production of a housing of this type for the Hall-effect sensor and the assembly of the Hall-effect sensor housing with the corresponding components is relatively complicated and therefore cost-intensive.

The object of the present invention is therefore to simplify the positioning of the Hall-effect sensor on the driving gear and/or the driving gear housing. The positioning should additionally be carried out in such a way that the Hall-effect sensor can be installed simply in volume production. Furthermore, damage to the Hall-effect sensor or other components should be prevented during installation of the Hall-effect sensor and its contacts/connections.

This object is achieved in accordance with the invention with a driving gear of the type described at the beginning by mounting the Hall-effect sensor on a plate which can be inserted into the housing. A housing for the Hall-effect sensor can advantageously be dispensed with. Because the plate with the Hall-effect sensor is inserted into the gear housing, the gear housing also forms a housing for the plate and/or for the Hall-effect sensor.

The housing can advantageously have locating grooves to position the plate and/or to position the open long sides of the plate. By means of such locating grooves, the plate can be inserted into the driving gear along one direction. This type of insertion is simple to perform, particularly in volume series production.

A particularly advantageous arrangement results from the fact that the locating grooves lie on a parallel plane to the axis of rotation of the shaft on which the pole wheel is mounted. Such an arrangement has the advantage that the plate on which the Hall-effect sensor is mounted can be brought relatively close to the pole wheel.

To prevent conductive circuits on the plate from coming into contact with the gear housing, which may be specifically of a metallic material, the plate can be electrically insulated in accordance with the invention in the area of the locating grooves.

Contact means are advantageously provided on the plate to cooperate with a plug. Such contact means can be contact pins, for example, or similar. In this way the signals detected by the Hall-effect sensor can be transmitted over a cable with a plug, for example to a central control unit.

A further embodiment of the invention is differentiated in that the connecting of the plug to the contact means is effected in a direction of contact parallel to the plate. This has the advantage that when they are connected, any resulting plug forces do not affect the plate directly.

In a particularly preferred embodiment of the invention, the contact means are supported against the driving gear housing on the side facing away from the direction of contact or from the plug, respectively. When the plug is connected to the contact means, any resulting plug forces are diverted into the gear housing without any possibility of damage to the plate.

The contact means can have specifically a first section disposed essentially perpendicular to the plate and a second section disposed essentially perpendicular to the first and pointing in the direction of contact.

The second section advantageously has contact pins pointing in the direction of contact to make contact with the plug. The first section is advantageously supported against the driving gear housing in such a way that plug forces operating in and/or counter to the direction of contact are absorbed by the driving gear housing. The plate can thereby be advantageously largely isolated from plug forces, whereby corresponding damage to the plate is prevented.

A further advantageous embodiment of the invention is characterized in that the plate is held in place in the driving gear housing by means of the gear housing cover. As a result, no additional means are needed to hold the plate in place. The gear housing cover assumes this task.

In order to hold the plate on which the Hall-effect sensor is located securely in position, particularly under preload, provision can be made to use a flexible sealing element between the gear housing cover and the gear housing. This can compensate for play in assembly and manufacturing tolerances in particular, which ensures that the plate is reliably retained in the gear housing.

In order to be able to connect the plug to the contact means even with the gear housing cover installed, under the invention the gear housing cover has an opening in the area of the plate or the contact means, respectively.

A further embodiment of the invention is characterized in that a wall or protective tongue is present between the rotating shaft and the plate. The plate and also the Hall-effect sensor can thereby be protected from the rotating shaft. In particular, lubricants on the shaft can not negatively affect the functionality of the Hall-effect sensor.

The object stated at the beginning is additionally achieved by an electric drive unit having a drive motor and a driving gear described in the preceding.

Additional advantageous embodiments and details of the invention can be found in the description which follows, in which the invention is described and explained in greater detail from the embodiment represented in the drawing.

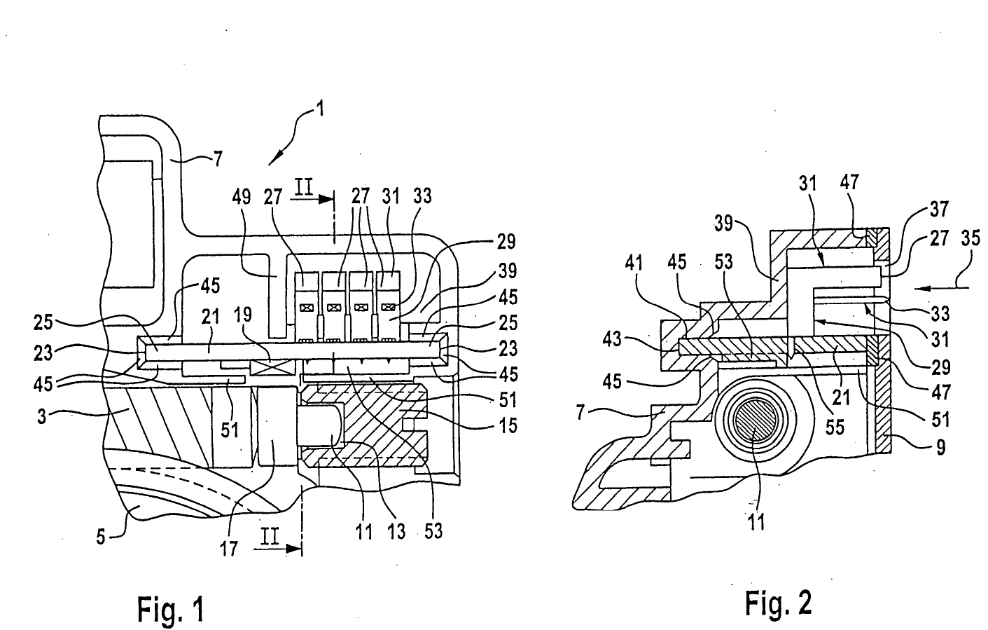

FIG. 1 shows the side view of a section of a driving gear in accordance with the invention without driving gear housing cover; and

FIG. 2 shows a section through the driving gear shown in FIG. 1 along the line II.

FIG. 1 shows the section of a worm gear 1 having a worm 3 and a worm wheel 5. The worm 3 is preferably configured as an extension of a rotor shaft of an electric motor not shown. The worm 3 and the worm wheel 5 are disposed in a gear housing 7. The housing 7 is essentially tub-shaped and open on the side facing the viewer. The driving gear can, however, be enclosed by means of a gear housing cover 9 shown in FIG. 2.

At the open end of the worm 3, the worm changes into a terminating boss 11. The terminating boss 11 is located by a recess 13 in a plug-shaped threaded bearing 15 screwed into the gear housing 7.

A hollow wheel in the form of an annular magnet 17 is disposed non-rotatably on the terminating boss 10.

FIG. 1 shows in addition a Hall-effect sensor 19 in the area of the annular magnet 17, which is located on a plate 21 which can be inserted into the housing 7. In the assembled state of the worm gear shown in FIG. 1, the Hall-effect sensor 19 is located in the area of the annular magnet which rotates with the shaft 3. Thus, magnetic impulses emanating from the rotating annular magnet 17 can be detected by the Hall-effect sensor 19.

The housing 7 has two oppositely disposed locating grooves 23 to position the plate 21 or the long sides 25 of the plate 21 facing away from each other. Thus the open edges of the long sides 25 of the plate 21 are positioned by the locating grooves 23. During assembly of the worm gear 1, the plate can be inserted into the locating grooves 23, where the locating grooves 23 lie in a plane parallel to the worm 3.

In the areas in which the plate 21 comes into contact with the housing 7 and/or the locating grooves 23, it is configured to be electrically insulated. This prevents in particular electrical conductors present on the plate 21 coming into contact with the housing 7.

Furthermore, it is clear from FIG. 1 and FIG. 2 that there are contact means 27 on the plate 21. The contact means 27 are intended to connect the Hall-effect sensor 19 electrically to a central control unit. To do this, the contact means 27 cooperate with a plug not shown, which can be connected to the contact means 27.

The contact means 27 have plug contacts 55 which pass through the plate 21 and are soldered to the plate 21. The contact means 27 further have a first section 29 disposed essentially perpendicular to the plate 21, on which section the plug contacts 53 are located. The contact means 27 further have a second section 31 disposed essentially perpendicular to the first section 29 and pointing in the direction of contact. The second section 31 has contact pins 33 to make contact with electric contacts on the plug which can be connected to the second section 31.

As is clear from FIG. 2, a suitable plug can be connected to the open ends of the contact pins 33, or of the second section 31 of the contact means 27 respectively. To enable the contact means 27 to make contact, or the plug to be attached even after installation of the cover 9, the cover 9 has an opening 37.

The first section 29 of the contact means 27 is supported, as can clearly be seen in FIG. 2, on a section 39 of the housing 7. The side of the contact means 27 facing the section 39 lies against the inside of the section 39. What this advantageously achieves is that when a plug is connected to the contact means 27, any resulting plug forces are directly diverted through the contact means 27 into the housing 7. The plate 21 and also the points at which the contact means 27 connects to the plate 21 are relieved of load. Consequently, no damage can occur if the plug is pushed onto the contact means 27 too heavily.

FIG. 2 further shows a third locating groove 41, which serves to position the long side 43 of the plate 21. The oppositely disposed locating grooves 23 and the locating groove 43 have chamfers on their respective upper edges which simplify insertion of the plate 21 into the driving gear housing 7.

As can also be clearly seen from FIG. 2, the plate 21 is held securely in the gear housing 7 by means of the gear housing cover 9. After the plate 21 is inserted into the locating grooves 23 and the locating groove 41, the cover 29 is bolted to the gear housing 7. As this is done, a flexibly configured gasket 47 between the cover 9 and the gear housing 7 presses the plate 21 into the gear housing 7 under preload. The long side 43 of the plate 21 facing away from the gear housing cover is thereby pressed against the base of locating groove 41. The plate 21 is thus retained permanently and dependably.

The gear housing 7 has in addition a wall section 49 protecting the contact means 27. Furthermore, various tongues 51 are provided which lie between the rotating armature 3 and the plate 21.

A spacer 53 is formed at the plate between the plate 21 and the tongue 51, the function of which is to position the plate 21 in the gear housing 7.

The worm gear shown in FIGS. 1 and 2 has the particular advantage that the installation of the plate 21 carrying the Hall-effect sensor 19 along an installation direction is possible in a very simple manner. No additional parts for attaching or locking are required to retain the plate 21 carrying the Hall-effect sensor.

The plate 21 is retained solely by means of the corresponding locating grooves 23 and 41 and by means of the housing cover 9. Moreover, no damage can be caused to the plate 21 because the contact means 27 are supported against the housing section 39 when a plug is pushed onto the contact means 27.

All the features presented in the description, the claims to follow and the drawing can be essential to the invention both individually and in any combination with each other.

What is claimed is:

1. Driving gear (1), especially worm gear, having an input shaft (3), an output shaft (5), a driving gear housing (7), a magnetic pole wheel (17) disposed on one of the two shafts (3), a Hall-effect sensor (19) supported on the driving gear housing (7) and located in the area of the pole wheel (17) to detect the rotary motion of the pole wheel (17) and/or the corresponding shaft (3), and a driving gear cover (9), characterized in that the Hall-effect sensor (19) is located on a plate (21) which can be inserted into the housing (7).

2. Driving gear (1) in accordance with claim 1, wherein the housing (7) has locating grooves (23, 41) to position the plate (21) or to locate the open long sides (25) of the plate (21).

3. Driving gear (1) in accordance with claim 1 or 2, wherein the locating grooves (23, 41) lie in a plane parallel to the rotational axis of the shaft (3).

4. Driving gear (1) in accordance with claim 1, 2 or 3, wherein the plate (21) is designed to be electrically insulated in the area of the locating grooves (23, 41).

5. Driving gear (1) in accordance with one of the preceding claims, wherein contact means (27) are provided on the plate (21) to cooperate with a plug.

6. Driving gear (1) in accordance with claim 5, wherein the connection of the plug to the contact means (27) is made in a direction of contact (35) parallel to the plate (21).

7. Driving gear (1) in accordance with claim 5 or 6, wherein the contact means (27) are supported against the driving gear housing (7, 39) on the side facing away from the direction of contact (35) and/or the plug.

8. Driving gear (1) in accordance with claim 5, 6 or 7, wherein the contact means (27) have a first section (29) disposed essentially perpendicular to the plate (21), and a second section disposed essentially perpendicular to the first section (29) and pointing toward the direction of contact (35).

9. Driving gear (1) in accordance with claim 8, wherein the second section (31) has contact pins (33) pointing toward the direction of contact (35) to make contact with the plug.

10. Driving gear (1) in accordance with claim 8 or 9, wherein the first section (39) is supported against the driving gear housing (7) in such a way that plug forces operating in and/or counter to the direction of contact are absorbed by the driving gear housing (7, 39).

11. Driving gear (1) in accordance with one of the preceding claims, wherein the plate (21) is firmly retained by means of the driving gear housing cover (9) in the driving gear housing (7).

12. Driving gear (1) in accordance with one of the preceding claims, wherein a flexible gasket (47) is provided between the driving gear housing cover (9) and the driving gear housing (7).

13. Driving gear (1) in accordance with one of the preceding claims, wherein the driving gear housing cover (9) has an opening (37) in the area of the plate (21) or the contact means (27) respectively.

14. Driving gear (1) in accordance with one of the preceding claims, wherein a wall (49) or a protective tongue (51) is provided between the rotating shaft (3) and the plate (21).

15. Electric drive unit having a drive motor and a driving gear (1) in accordance with at least one of the preceding claims.
